(19) United States
(12) Patent Application Publication
(10) Pub. No.: US 2002/0097216 A1
(43) Pub. Date: Jul. 25, 2002

(54) Animated video device with synchronized voice

(76) Inventor: John Wook Chae, Flower Hill, NY (US)

Correspondence Address: BIRCH STEWART KOLASCH & BIRCH, PO BOX 747, FALLS CHURCH, VA, 22040-0747, US

(21) Appl. No.: 09/897,062

(22) Filed: Jul. 3, 2001

Related U.S. Application Data
(60) Provisional application No. 60/263,769, filed on Jan. 25, 2001.

(51) Int. Cl. G09G 3/34

(52) U.S. Cl. 345/108

(57) ABSTRACT

An animated video device includes a support having a plurality of different images formed thereon and a transparent plate. The transparent plate has a grooved surface on one side thereof. Furthermore, the transparent plate is mounted adjacent and mounted for movement relative to the support by a driving mechanism. The driving mechanism includes a solenoid including a thin permanent magnet reciprocable within a coil a lever connected to the solenoid and mounted for pivotable movement to convert the motion of the solenoid to one of the support and the transparent plate.

### BACKGROUND OF THE INVENTION 1. Field of the Invention

The present invention is directed to an animated video device with synchronized voice. In particular, the present invention is directed to an animated video device which includes mechanical movement synchronized with sound to produce an animated video device with synchronized voice.

2. Description of Background Art

Devices which use a lenticular to change an underlying image are known. For example, U.S. Pat. No. 5,757,545 to Wu et al., U.S. Pat. No. 5,724,758 to Gulick, Jr., and U.S. Pat. No. 5,716,682 to Lovison et al. disclose various mechanisms which utilize a lenticular in order to change an underlying image, depending upon the line of sight of a viewer. However, in the devices of the background art, it is necessary to change the line of sight of the viewer in order for the various underlying images to be visualized.

Other devices of the background art include a mechanism for moving the lenticular and image with respect to each other in order to avoid the necessity of changing the line of sight of the viewer. However, these types of device are generally complicated structures which are expensive to manufacture. Furthermore, the devices of the background art are not low profile and therefore are not appropriate for use in a greeting card or small sized toys and games.

SUMMARY OF THE INVENTION

It is an object of the present invention to make up for the deficiencies of the background art by providing a video simulation system which avoids the necessity of a user moving with respect to the device to view a plurality of different images.

It is a further object of the present invention to provide a low profile video simulation system which can be used in greeting cards, small sized toys, etc.

It is yet another object of the present invention to provide a video simulation system which is inexpensive to manufacture. Accordingly, it is feasible to use the video simulation system of the present invention in inexpensive products such as greeting cards and small sized toys and games.

The above objects of the present invention have been accomplished by providing an animated video device, comprising:

a support, said support having a plurality of different images formed thereon;

a transparent plate, said transparent plate having a grooved surface on one side thereof, said transparent plate being mounted adjacent and mounted for movement relative to said support; and

a driving mechanism for driving the support and transparent plate relative to each other, said driving mechanism comprising:

a solenoid, said solenoid including a thin permanent magnet reciprocable within a coil; and

a lever mounted for pivotable movement, said lever being connected to the permanent magnet of said solenoid to convert the motion of the solenoid to one of the support and the transparent plate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a plan view of the animated video device of the present invention;

FIG. 2 is a cross-sectional view of the animated video device of FIG. 1 along the line II-II;

FIG. 3 is a diagram of theory of similar triangles for determining the terminal points of the relative movement of the picture; and

FIGS. 4 and 5 are pulse diagrams for the operation of the coil in the device of the present invention.

### DESCRIPTION OF THE PREFERRED EMBODIMENTS

The device of the present invention combines mechanical movement with light ray refraction to produce a moving image with sound. The effect of the present invention can be applied to a video simulation system in greeting cards, video games, toys, etc. The control of the device of the present invention is through the use of an integrated circuit. Furthermore, the graphic movement of the device is accomplished through synchronization of mechanical movement with an electronic signal for producing sound.

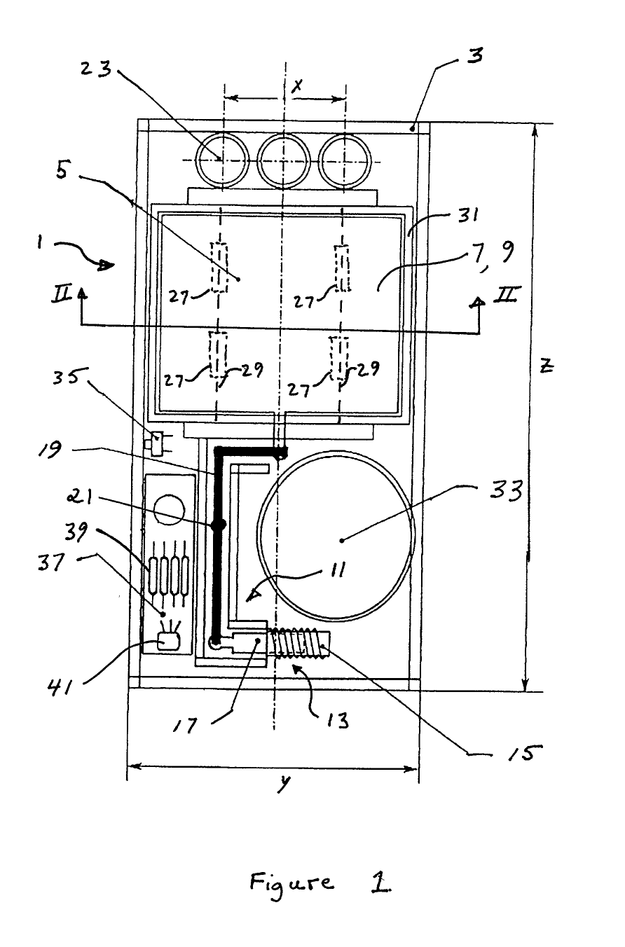

A preferred embodiment of the invention will now be described with reference to FIG. 1. FIG. 1 illustrates a thin profile device 1 which would preferably be used in a greeting card (not shown); however, the device of the present invention may also be used in other applications such as toys, games, etc. The device 1 of the present invention includes a stand 3 on which the various components are mounted. The stand 3 is preferably constructed of a plastic material; however, the stand 3 can also be made of other materials as well.

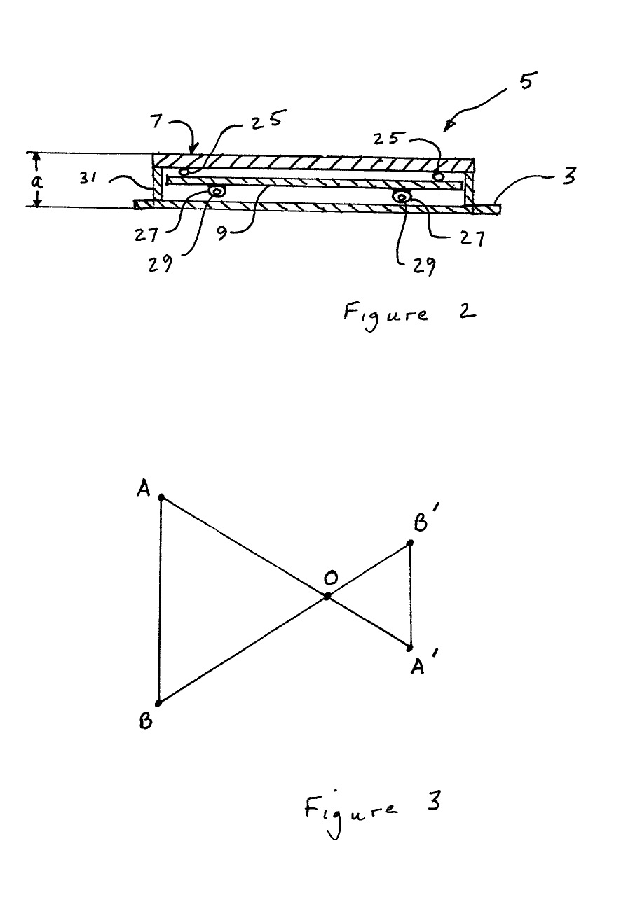

A cartoon and glass assembly 5 is mounted on the stand. Referring to FIGS. 1 and 2, the cartoon and glass assembly 5 includes a transparent plate 7 having a grooved or milled surface formed on one surface thereof. In addition, a support 9, which includes a plurality of pictures mounted on one side thereof is mounted behind the transparent plate. Furthermore, one of the support 9 and the transparent plate 7 is movable with respect to the other in order to move the plurality of pictures with respect to the field of vision of a user. This causes a virtual image to be experienced by the user without the necessity of the user moving their eyes. The amount of movement should be the distance of the pitch between adjacent grooves in the transparent plate. This technology is not new and therefore will not be further described.

Referring again to FIG. 1, a driving mechanism 11 for the cartoon and glass assembly will be described. A solenoid 13 includes a coil 15 and a movable permanent magnet 17. The permanent magnet 17 is made of a flat plate in order to allow for the solenoid 11 to be made very thin. The magnet 17 is connected to a lever 19, which is pivotably mounted to one of the transparent plate and the support by a pivot 21. Accordingly, as the solenoid 13 is operated, the lever 19 pivots about the pivot 21 to drive one of the support 9 and the transparent plate 7 of the cartoon and glass assembly 5 with respect to each other.

The coil 15 of the solenoid 13 may have two windings in opposite directions in order for a force to be applied to the magnet 17 in opposite directions. This eliminates the necessity of a spring to return the magnet 17 to the original position and therefore the necessity of a force to overcome the force of the spring. It should be understood; however, that a spring can be included, depending on the particular application. The elimination of the spring allows the necessary battery power to be decreased, since the additional force to overcome the spring force has been eliminated.

Instead of providing two windings in the coil, the same can be accomplished with one coil if the single coil is operated in two opposite directions to change the magnetic field. Accordingly, the direction in which the coil is operated will determine the direction in which the permanent magnet 17 moves. Therefore, the necessity for a spring is also eliminated.

Although a driving mechanism 11 which includes a solenoid 13 and a lever 19 has been described, it will be understood by the ordinary artisan that other mechanisms for causing relative motion between the support and transparent plate are also possible. For example, a mechanism for converting circular motion to linear motion, such as a motor, cam and gear assembly is also possible. However, the preferred embodiment is a thin solenoid, since this mechanism allows the resulting device to be made thinner than other driving mechanisms.

Referring to FIG. 1, the magnet is preferably mounted for movement in a horizontal direction. This eliminates the necessity of having to overcome gravity to move the magnet in an upward, vertical direction. Accordingly, it requires less power to move the magnet 17, and therefore, a smaller battery 23 can be used to operate the device 1 of the present invention.

The lever 19 is used to amplify the amount of displacement of the solenoid 13 so that the movement of the cartoon and glass assembly 5 is greater than the displacement of the magnet 17. In addition, the pivot 21 of the lever should be selected to balance the force needed to operate the cartoon and glass assembly 5 and the amplification of the lever 19. Accordingly, the pivot 21 will be selected depending on a particular application.

Mounted between the transparent plate 7 and the support 9 is a mechanism for reducing friction between the two elements. If the support 9 and the transparent plate 7 were in face-to-face contact, the friction force between the two elements would require additional force to cause relative motion. Referring to FIG. 2, the preferred mechanism is the use of metal wire 25, such as piano wire, located between the support 9 and the transparent plate 7. The metal wire 25 should be mounted on opposite sides of the support 9 and should extend in the vertical direction. This provides a gap between the two elements such that the only friction experienced is from contact with the metal wire 25. This reduces the friction between the support 9 and the transparent plate 7 and therefore, less power is required to cause the necessary relative motion. It will be understood to the ordinary artisan that other mechanisms such as roller balls can be used to reduce friction as well. Furthermore, for particular applications, there may not be a necessity for a mechanism to reduce friction.

Referring again to FIG. 2, the support 9 is illustrated as being mounted for movement, rather than the transparent plate 7. The support 9 includes a plurality of guides 27 mounted to a surface facing away from the transparent plate 7. The guides can be a tube, a wound coil, etc. that supports the support 9 for movement along a plurality of guide rods 29 which are supported on the stand 3 and extend in the vertical direction. In FIG. 2, the guide rods 29 are supported on a wall 31 of the stand 3.

Although guides 27 and guide rods 29 have been illustrated as supporting the support 9 for movement, it should be understood that other mechanisms for supporting the support 9 for movement would be readily appreciated by the ordinary artisan. Furthermore, it may also be possible to eliminate the guides and guide rods completely in order that the support and stand 3 are in face-to-face contact. This would make it possible to construct the device 1 even thinner that that illustrated in FIG. 2. However, the friction due to the face-to-face contact would increase. Accordingly, a metal wire such as the metal wire 25 between the transparent plate 7 and the support 9 may also be used to reduce friction between the support 9 and the stand 3 for particular applications.

The device 1 of the present invention also includes a speaker 33, batteries 23, a switch 35, and a circuit board 37. The circuit board 37 includes transistors 39 and an integrated circuit (IC) chip 41. This allows the device 1 to include sound in addition to the cartoon movement. The sound can be synchronized with the cartoon through the IC chip 41 so that the movement of the cartoon and the sound are not random. Specifically, the sound can be synchronized with the motion so that the sound conforms to the motion. For example, a cartoon may include movement of the mouth of the cartoon. Accordingly, the sound of words from the cartoon can be synchronized with mouth movement including pauses between the words. The IC chip 41 can also be used to control the pitch, tone, voice, etc. to be synchronized with the motion of the cartoon.

The switch 35 should be oriented to be operated, depending on the application. For example, if the device 1 of the present invention is for use with a greeting card, the switch 35 should be operable upon release for operation when the card is opened. Furthermore, if the device 1 of the present invention is for being used in a toy, such as a stuffed animal, the switch 35 should be operable when pressed, rather than released as in the greeting card example. In the case of a stuffed animal, it is unnecessary to have the switch and other components mounted on the stand 3. For example, the switch can be mounted in the body of the stuffed animal at a remote location. As long as there is an electrical connection to the remaining portions of the device 1, the device 1 will operate as intended. For example, when the device 1 of the present invention is used in a stuffed animal, the cartoon and glass assembly can be mounted in the head of the stuffed animal, while the switch can be mounted in the body, hands, feet, etc.

In addition, the device of the present invention may include a recording device (not shown) to allow a user to record their own voice to be replayed with movement of the cartoon. Furthermore, lights may be provided for operation with the sound from the speaker 33 and the movement of the cartoon and glass assembly 5.

Referring again to FIG. 1, it is possible to construct the device 1 of the present invention in a very small size. It is possible to construct the length z at least as small as 143 mm, and the width y at least as small as 77 mm. In addition, it is possible to provide three thin profile batteries within a space x at least as small as 32 mm and still provide sufficient power to operate the device 1. Finally, as illustrated in FIG. 2, the device 1 of the present invention can be constructed having a thickness a at least as small as 10 mm. Accordingly, the device 1 of the present invention can be used in very small products such as greeting cards, small sized toys and games, etc.

A preferred operation of the device 1 of the present invention will now be described. It should be recognized that the following description should not be used to limit the scope of the present invention, since the device 1 of the present invention should be constructed specifically for a particular application. Accordingly, the cost, size, weight, etc. should be taken into consideration when constructing the device 1 of the present invention.

The appearance of the device 1 of the present invention is similar to that of a thin profile, portable calculator. When the switch 35 is operated, the device 1 plays a song, for example, “Happy Birthday to you,” through the speaker 33. At the same time, the cartoon and glass assembly 5 will display a cartoon picture. The mouth of the cartoon will open and close, based on the voice variation of the song, not by the music. Accordingly, when the words of the song are being played, the mouth of the cartoon is moved in synchronization therewith, including pauses in the words of the song. When the song is completed, the moving of the cartoon ends. Furthermore, if the switch 35 is operated again, the above will be repeated.

The device 1 of the present invention includes mechanical movement and electronic control. Specifically, the mechanical movement is accomplished by the picture on the support 9 that is moved with respect to the transparent plate 7 by the driving mechanism 11. Furthermore, the electronic control is accomplished by the IC 41, the transistor 39, the switch 35, the coil 15, the magnet 17 and the speaker 33.

The control flow will now be described with reference to FIG. 1. The battery 23 supports the energy for the entire system of the device 1. When the switch 35 is on, two signals are produced. One signal is amplified by the transistor 39 and sent to the speaker 33 to produce a song. The other signal is sent to the coil 15 to control the movement of the magnet 17 based on the programming of the IC 41. The movement of the magnet 17 is transmitted through the lever 19 to change the moving direction of the support 9 or the transparent plate 7 to accomplish relative movement between the picture on the support 9 and the transparent plate 7, and therefore cause the animation effect of the cartoon and glass assembly 5. The two signals start and stop simultaneously.

As described above, the picture on the support 9 is moved with respect to the transparent plate 7 in order for refraction to occur and change the image experienced by the viewer. Accordingly, it is unnecessary for the viewer to change their line of sight. The specially designed surface of the glass will produce the proper effect. Specifically, optical refraction will cause the mouth of the cartoon to open and close according to the song being played.

The movement of the picture with respect to the transparent plate 7 must be very precise. In order to obtain a satisfactory result, three important issues must be considered:

i) the output power of the battery must be kept to a minimum to reduce the size of the device 1;

ii) the weight of the mechanical parts must be kept to a minimum; and

iii) the friction during the picture movement must be minimized.

The above is accomplished by providing a picture weight which is ideally less than 5 grams. Furthermore, as mentioned above, metal wire 25 can be used as the main bearing. Accordingly, the weight of the picture is concentrated on the metal wire 25 to prevent face-to-face contact between the picture and the transparent plate 7.

To determine the two terminal points of the relative movement of the picture requires precise calculation. However, difficulties arise when attempting to determine the location of the two points with sufficient accuracy. Accordingly, the theory of similar triangles can be utilized. For example, referring to FIG. 3, if:

AOB˜A′OB′, then

OA/OA′=OB/OB′=AB/A′B′

If OA/OA′=3, then AB=3A′B′

In the above situation, the precision is adjusted 3 times and the actual precision is therefore reduced.

In addition, the magnet 17 is made of steel which is very heavy. Therefore, the movement of the magnet is set to be in the horizontal direction. Accordingly, the amount of power required is decreased, since the only force that must be overcome is the weight of the support 9 and picture or the transparent plate 7. This construction will reduce the friction force as well.

In order to reduce the thickness of the device, an ABS board of 2.5 mm can be used as the stand 3. The picture, lever 19, and electronic components will fit on one board. Furthermore, in applications where the thickness is not the most important factor, such as in stuffed animals, the electrical components and lever 19 can be mounted on an opposite side of the stand 3. Accordingly, the length of the stand 3 will be decreased. As will be readily understood to the ordinary artisan, it would be necessary to provide a slot in the stand 3 to transfer the movement of the lever 19 to the cartoon and glass assembly 5.

In order to make the device 1 of the present invention reliable and stable, the control parts are used to make the power stable and the moving reliable. With this construction, the device 1 is constructed in small size, has a low cost, has a loud voice, and uses low power.

With regard to the IC 41, the choice will be based upon a particular application. Preferably, the IC 41 includes 3 outlets. The first outlet is connected to the speaker, the second outlet is connected to the coil with a signal to push the magnet, and the third outlet is connected to the coil with a signal to pull the magnet. The preferred IC 41 also includes multiple input lines, is programmable, and requires a minimum of memory. Accordingly, the song to be played is divided into individual components. In addition, when the IC 41 is not in use, it will enter an idle state and power consumption will be decreased.

In view of the above, the preferred IC 41 is W528XXX manufactured by the Winbond Company in Taiwan. However, it should be readily understood that different integrated circuits may also be used.

An example will now be provided to illustrate how the IC 41 operates in the device 1 of the present invention. For example, the song “Happy Birthday to you” is divided into 9 components identified by A, B, C, D, E, F, G, H, and I. The song consisted of the above 9 components is as follows:

A-52-B-130-C-560-A-74-B-130-D-560-A-52-E-130-F-560-G-190-H-100-I

a) the letters represent components of the song; and

b) the numbers represent the time intervals for each component in units of ms.

The movement of the magnet 17 proceeds back and forth in the horizontal direction periodically under the power from the battery 23. The motion of the magnet is in conformance with Faraday's Theory.

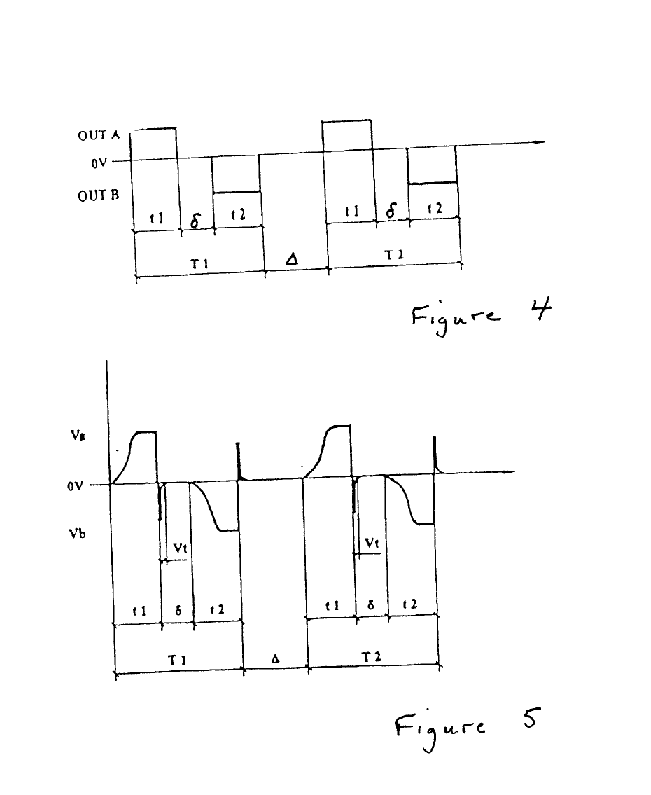

The control of the coil 15 from the IC 41 can be understood from a review of FIGS. 4 and 5. In FIG. 4:

t1=OUT A pulse width;

t2=OUT B pulse width;

δ=the interval between t1 and t2;

T=t1+t2+δ=one cycle; and

Δ=the interval between two cycles.

Referring to FIG. 5, the coil will receive the pulse as follows:

Vt=the reverse current time delay. When Vt=δ, the reverse voltage imposed on the reverse pulse, Vb=1.414Va. However, if δ>>Vt, we may assume Vb=Va and therefore ignore the reverse voltage. In order to compose the song “Happy Birthday to you,” A+52 is the shortest cycle. Accordingly, Tmin=A and Δ=52 ms.

In order to reduce the cost and minimize the surrounding components of the device 1 of the present invention, the magnet 17 is preferably wound by two coils in two different directions as controlled by the above-mentioned outputs of the IC 41. In this manner, the cost of the IC 41 will increase, but only four transistors 39 are necessary. Fewer transistors will decrease the size of the device 1 even further.

The following considerations should be kept in mind when determining the best way in which to construct the device 1 of the present invention for a particular application. First, the device 1 should not be operated continuously. The maximum current in the coil 15 is 15 ma. The batteries are constructed from thin profile button batteries which have been shown to run out after 110 uses. Accordingly, it is necessary to replace the batteries more often under continuous use. The construction of the device 1 is very accurate and therefore it is very fragile. Furthermore, operation of the device 1 in an area which is under a strong magnetic field should be avoided.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An animated video device, comprising:
a support, said support having a plurality of different images formed thereon;
a transparent plate, said transparent plate having a grooved surface on one side thereof, said transparent plate being mounted adjacent and mounted for movement relative to said support; and
a driving mechanism for driving the support and transparent plate relative to each other, said driving mechanism comprising:
a solenoid, said solenoid including a thin permanent magnet reciprocable within a coil; and
a lever mounted for pivotable movement, said lever being connected to the permanent magnet of said solenoid to convert the motion of the solenoid to one of the support and the transparent plate.

2. The animated video device according to claim 1, further comprising:
a speaker for emitting a sound; and
a device for synchronizing the movement of the transparent plate relative to the support with the sound from the speaker.

3. The animated video device according to claim 2, wherein said device for synchronizing movement is an integrated circuit.

4. The animated video device according to claim 1, wherein said solenoid includes two coils wound in opposite directions, each of said two coils being alternatingly operated to reciprocate said magnet, wherein the necessity for a spring to return said magnet to an original position is avoided.

5. The animated video device according to claim 1, wherein said lever is attached to said transparent plate to move said transparent plate with respect to said support.

6. The animated video device according to claim 1, wherein said lever is attached to said support to move said support relative to said transparent plate.

7. The animated video device according to claim 1, wherein said transparent plate and said support are separated from each other by a bearing to reduce the friction therebetween.

8. The animated video device according to claim 7, wherein said bearing is a pair of metal wires supported between said transparent plate and said support, said metal wires extending in a direction of relative movement of said transparent plate and said support.

9. The animated video device according to claim 1, wherein said animated video device is a greeting card and is operable from a switch upon opening of said greeting card.

10. The animated video device according to claim 1, wherein said animated video device is a stuffed animal and is operable upon pressing a switch located in a body of the stuffed animal.

11. A driving mechanism for an animated video device, the animated video device including a support having a plurality of different images formed thereon and a transparent plate having a grooved surface on one side thereof, the transparent plate being mounted for movement relative to the support, said driving mechanism comprising:
a solenoid, said solenoid including a thin permanent magnet reciprocable within a coil; and
a lever mounted for pivotable movement, said lever being connected to the permanent magnet of said solenoid to convert the motion of the solenoid to the animated video device.

12. The driving mechanism for an animated video device according to claim 11, wherein said solenoid includes two coils wound in opposite directions, each of said two coils being alternatingly operated to reciprocate said magnet, wherein the necessity for a spring to return said magnet to an original position is avoided.
